(19) United States
(12) Patent Application Publication
(10) Pub. No.: US 2005/0183276 A1
(43) Pub. Date: Aug. 25, 2005

(54) Cam jointed interlocking segmented level with insert

(76) Inventor: Dane Scarborough, Hailey, ID (US)

Correspondence Address: STEPHEN M. NIPPER;DYKAS, SHAVER & NIPPER, LLP, PO BOX 877, BOISE, ID, 83701-0877, US

(21) Appl. No.: 11/064,625

(22) Filed: Feb. 23, 2005

Related U.S. Application Data
(60) Provisional application No. 60/547,248, filed on Feb. 23, 2004.

(51) Int. Cl. G01C 9/00

(52) U.S. Cl. 33/374

(57) ABSTRACT

A compound level comprising a first straight, linear leveling section and a second straight, linear leveling section. Each section includes at least one flat surface configured for contact with a work surface and at least one indicating level. The first section includes an engagement tongue that is configured for connection with an engagement groove of the second section, thus providing co-linear interconnection of the leveling sections and forming an integral linear structure for positioning the flat surfaces of each section in mutually coplanar contiguous alignment. A locking cam provides a lateral force on the tongue such that the connecting surfaces of the first and second sections are maintained in desired mutual contact.

### PRIORITY

This application claims the priority date of the provisional application entitled CAM JOINTED INTERLOCKING SEGMENTED LEVEL WITH INSERT filed by Dane Scarborough on Feb. 23, 2004 with application Ser. No. 60/547,248.

### BACKGROUND OF THE INVENTION

1. Field of the Invention

This invention relates generally to carpenters' tools, and more particularly to levels for determining the approximate proper linearity of items. This invention more particularly is directed to a collapsible, compound level comprised of various interlocking sections that interact to support and form a segmented level having a desired length.

2. Background of the Invention

Carpenters, during the normal course of their work, face a variety of different tasks. Many of these tasks involve making appropriate determinations as to the appropriate placement of various construction elements and the fastening or securing of these items in these designated areas. Often times these requirements will include the making of determinations as to the proper location, orientation, and position of these construction elements and whether or not the placement of these elements has been met. Depending upon the size of the pieces involved and the location where these pieces are to be placed, various different lengths and sizes of leveling and squaring tools may be required. For example, in the action of installing a cabinet in a designated location, the surface from which the cabinet is to be attached must be measured to ensure that the cabinet will safely connect to this location. After this has taken place, the cabinet may be placed in a position and the cabinet measured to ensure that a proper level exists in both vertical and horizontal directions. Next, the shelves inside of the cabinet may then need to be assessed to ensure that the location and position of these items has been properly positioned. As the dimension of the area to be assessed decreases, larger measuring devices are no longer required.

Various carpenters' tools have been developed that combine the number of functions that a single tool can perform. These various tools also enable a party to modify the shape and configuration of a tool to provide instruments of various lengths and sizes. For example, extendible levels exist in the prior art, such as my prior patent, U.S. Pat. No. 5,433,011, the disclosure of which is incorporated herein by reference. Extendible levels are useful for use in tasks that require either a short or long level. Such prior art devices, however, are not well suited for working with surfaces that are non-linear, such as corners and other 90-degree and 45-degree angled surfaces. Such devices cannot function as other types of tools, for example, as T-squares or as a right angle ruler. Further, such prior art devices are considerably weaker in their extended configuration than in their compact configuration, thereby tending to lead these devices to be more prone to damage and injury, particularly when the device is extended. Once such a device is damaged, these devices are typically worth very little because the correctness of the measuring shape has been irreparably altered. Any actions that would be taken from this point to straighten the item would prove to be costly and damaging to the device itself.

It is well known that tools at construction sites often experience many harsh, potentially damaging forces, including being dropped, hit, having heavy items fall upon them, being exposed to harsh elemental conditions, and other factors. Moreover, because of the types of materials that are utilized in the typical construction of these devices and the overall make up and configuration of these devices, relatively small forces placed upon these devices can cause great amounts of stress and damage and can cause the devices to be bent or forced out of proper alignment. Thus resulting in erroneous measurements and readings, and destroying the utility of the tool. Furthermore, such devices are typically limited to a maximum extension length and thus cannot provide an extended, contiguous working surface.

Clearly, then, there is a need for a carpenter's tool that is capable of determining a level position across both short and arbitrarily long distances. Such a device needs to be durable, relatively easy to manufacture, and remain straight over large distances. The linearity of such a device, moreover, could be verified at multiple points along its length. Such a needed device, further, could be quickly adapted for use as a T-square, a right-angle ruler or other measuring and leveling tools. Still further, such a needed device would be collapsible and, when collapsed, would fit into a standard toolbox. Still further, such a needed device would be easy to use and adapt to various configurations. Embodiments of the present invention fulfill these needs and provide further related advantages.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a compound level made up of a first straight, linear leveling section and a second straight, linear leveling section. Each section includes at least one flat surface, and preferably not less than three flat surfaces. Each surface is dimensioned for contact with a work surface. Each section also contains a first bubble level and a second bubble level arranged for indicating level and plumb, respectively, of the work surface. The first section includes an engagement tongue that is configured for connection with an engagement groove of a second section, thus providing co-linear interconnection of the leveling sections and forming an integral linear structure for positioning the flat surfaces of each section in mutually coplanar contiguous alignment. The engagement tongue has an oblique surface and an end stop surface for contacting a mating oblique surface and a mating end stop surface of the engagement groove. The second section includes a lateral, force producing locking cam that applies a lateral force on the tongue such that the oblique surfaces and the end stop surfaces are caused to move into mutual contact, thus achieving alignment of the flat surfaces of both the first and second sections.

This same invention includes various modifications and can be utilized with a variety of other devices and prior inventions. These include L-shaped sections that form a true right angle, as well as T-shaped sections, which likewise form true right angles. Each of these types of devices preferably includes engagement tongues at one end and an engagement groove at the opposing end. As such, the L-shaped and T-shaped sections may be engaged with any of the other leveling sections to form a right angle structure. Examples of these T-shaped and L-shaped sections are found in U.S. Pat. Nos. 5,433,011 and 5,832,618, the contents of which are herein incorporated by reference.

The present invention is a carpenter's tool that is useful for leveling across short and arbitrarily long distances, and in the preferred embodiment provides three working surfaces. The present device is durable, relatively easy to manufacture, and remains generally, linearly true over large distances. The present invention is furthermore completely modifiable so as to allow the device to be variously reconfigured and modified according to the various needs of a user. The linearity of the present invention can in fact, be verified at multiple points along its length. Furthermore, the present device can be quickly adapted for use as a T-square, a right-angle rule or other measuring and leveling tool. When collapsed, the present invention may also be adapted to fit into a standard sized toolbox. The present device is easy to use and can be quickly adapted to various configurations of various lengths. Other features and advantages of the present invention will become apparent from the following more detailed description, taken in conjunction with the accompanying drawings, which illustrate, by way of example, the principles of the invention.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective illustration of a preferred first embodiment of the invention, illustrating a multi-sectioned level formed by the joining of a first leveling section, an additional leveling section, and a second leveling section engaged such that flat surfaces of each section are in mutually coplanar contiguous alignment.

FIG. 2 is an exploded perspective illustration of the preferred embodiment of the invention shown in FIG. 1. This Figure shows the first section, the additional leveling section, the second section, and first and second engagement portions of each section.

FIG. 3 is a cross-sectional view of the preferred embodiment of the invention, taken generally along lines 3-3 of FIG. 1, and further illustrating the first and second engagement portions of the invention.

### DETAILED DESCRIPTION OF THE PREFERRED EMBODIMENT

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

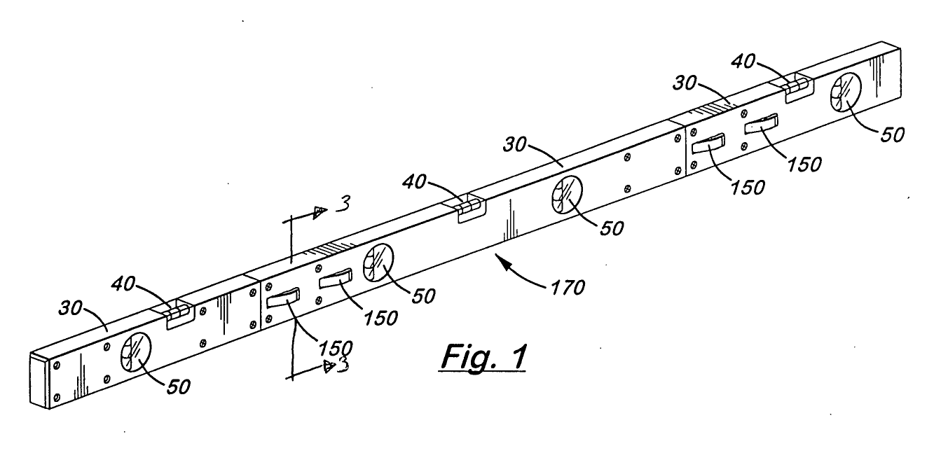

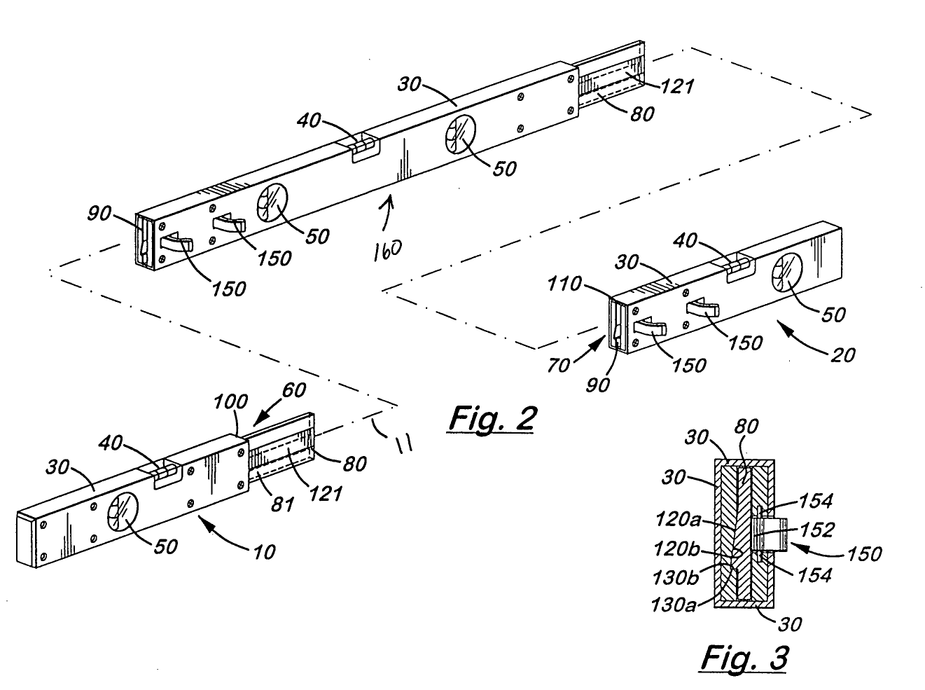

FIGS. 1 and 2 show a multi section level device 170 comprising a first linear leveling section 10 and a second linear leveling section 20. Each section 10, 20 includes at least one flat surface 30, but preferably not less than three flat surfaces 30, for contact with a work surface (not shown). Further, each section 10, 20 preferably includes a first orientation sensor 40 and a second orientation sensor 50 arranged for indicating level and plumb, respectively, of the work surface. Each section 10, 20 further includes a longitudinal axis 11 extending in parallel with the flat surfaces 30 (FIG. 2) and provides opposing ends defining the longitudinal extent of the section.

The first section 10 provides a first engagement portion 60, and the second section 20 provides a second engagement portion 70. First and second engagement portions 60, 70 provide co-linear interconnection of the leveling sections 10, 20, thereby forming an integral linear structure for positioning the flat surfaces 30 of each section 10, 20 in mutually coplanar contiguous alignment. Preferably, the first engagement portion 60 includes a tongue 80, and the second engagement portion 70 includes a groove 90 (FIG. 2). The tongue 80 extends from an end 100 of the first section 10, and the groove 90 is incorporated in a section end 110 of the second section 20. The tongue 80 preferably has an oblique mating surface 120a, and mating end stop surface 130a (as shown in FIG. 3).

The side of the tongue 81 opposite from these mating surfaces has an insert 121 therein that is made of a durable or wear-resistant material. Examples of suitable material include, but are not limited to, nylon and Teflon®. This insert 121 is generally permanently affixed to the tongue 80 and provides a substantial advantage in that it prevents wear upon the tongue 80 caused by the second engagement portion 70 against the tongue 80. This insert 121 also provides a base against which the second engagement portion 70 can be connected. The oblique mating surface 120a and the mating end stop surface 130a are configured to contact a mating oblique surface 120b and a mating end stop surface 130b of the groove 90 (FIG. 3). The oblique surface 120a and the mating end stop surface 130a form an acute angle, as do the oblique surface 120b and the mating end stop surface 130b.

The second engagement portion 70 includes a locking cam 150 for applying a lateral force on the tongue 80. The lateral force is such that the oblique surfaces 120a, 120b and the end stop surfaces 130a, 130b are caused to move into mutual contact, thereby achieving alignment of the flat surfaces 30 of both the first and second sections 10, 20.

In this preferred embodiment, the locking cam 150 is comprised of a lever 152 and a cam 150. The cam and lever devices 150, 152 are connected to the second end portion by cam pins 154. The cam portions 152 are configured to engage and push against the tongue portion 80 so as to maintain the mating surfaces 120, 130 in contact. Preferably, the cams are integrally connected with the levers 152 so as to allow the cam 150 to be rotated and positioned in the desired force producing position. An insert strip 121 is placed upon the tongue 80 in such a position so as to be contacted by the cams 150 of the present arrangement. This insert 121 prevents unwanted wear upon the tongue 80 and increases the effectiveness and durability of connection between the first and second pieces 20, 30.

In operation, the user engages the tongue 80 of the first section 10 with the groove 90 of the second section 20 and then rotates the cams 150 against the insert strip 121, until a position where movement of the tongue 80 with the groove 90 is prohibited. Ideally, this also occurs when the cams 150 are locked into place. These cams then force the oblique surfaces 120a, 120b together, which causes the oblique surface 120a of the tongue 80 to slide relative to the oblique surface 120b of the groove 90 until the end stop surface 130a of the tongue 80 is forced firmly against the end stop surface 130b of the groove 90.

Additional leveling sections 160 may also be included. Each additional leveling section 160 having the flat surface 30 for contacting with the work surface, the first engagement portions 60 at one end, and the second engagement portions 70 at the opposing end. As such, the additional leveling sections 160 may be engaged with any of the other leveling sections 10, 20, 160 for forming a multi-section level 170 (FIG. 1). Each section 160 is aligned with the other sections 10, 20, 160 so that all of the flat surfaces 30 of the sections 10, 20, 160 are in mutual coplanar contiguous alignment.

Each section 10, 20, 160 is preferably formed from a strong, rigid material, such as hardened steel or aluminum. Clearly, however, any suitably strong, rigid material may be used. Each section 10, 20, 160 may be partially formed by an extrusion process, as can the tongue 80 of each second engagement portions 70. Likewise, however, each section 10, 20, 160 may also be cast of metal. As illustrated in FIGS. 2 and 3, each engagement portions 60, 70 may be fixed to each section 10, 20, 160 with a plurality of set screws. Further, an end cap may replace the engagement portions 60, 70 on any end of any section 10, 20, 160, if desired (FIGS. 1 and 2). Further, first and second orientation sensors 40, 50 are preferably conventional bubble levels comprising a fluid-filled linear column with an air bubble, or the like. However, other orientation sensor may be used, such as electronic orientation sensor, or the like.

While the invention has been described with reference to a preferred embodiment, it is to be clearly understood by those skilled in the art that the invention is not limited thereto. For example, each section 10, 20, 160 may be manufactured without the first or second orientation sensors 40, 50 thus providing an expandable straight edge device. Thus, the scope of the invention is to be interpreted only in conjunction with the appended claims.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A compound level for sensing orientation of a work surface comprising:
at least a first leveling section and a second leveling section, each of said sections having first and second ends, including a longitudinal axis and at least one external flat surface, said external parallel surface positioned parallel to the longitudinal axis, for contact with the work surface and at least one orientation sensor positioned for indicating orientation of the work surface when the external flat surface is brought into contact therewith;
said first section further comprising a tongue extending longitudinally from one of said ends;
said second section defining a longitudinally oriented groove within one of said ends, said groove positioned and configured to accept said tongue therein, said groove including a longitudinally directed, flat, end-stop surface fixed in parallel with said external flat surface, and a longitudinally directed, flat, oblique surface positioned at an acute angle with said end-stop surface, said tongue having end-stop and oblique, longitudinally directed flat surfaces positioned at said acute angle therebetween and sized and oriented for intimately mating with the end-stop and oblique surfaces of the groove respectively; and
a locking cam located within said second section, said locking cam configured to apply a lateral force upon said tongue; said lateral force directed offset to, and approximately in parallel with, said external flat surface, such that the respective oblique and end stop surfaces are caused to move into mutual contact, thereby achieving coplanar alignment of the respective external flat surfaces of the respective sections.

2. The compound level of claim 1 wherein said locking cam comprises a lever integrally formed with said cam.

3. The compound level of claim 2 wherein said locking cam pivotally connected within said second section by cam pins.

4. The compound level of claim 1 wherein said tongue has an insert made of a wear resistant material connected thereto.

5. The compound level of claim 1 further comprising at least one third leveling section, said third leveling section providing first and second ends and having an external flat surface for contact with the work surface, and at least one orientation sensor arranged for indicating orientation of the work surface, and a further tongue extending from one of the first and second ends, and a further groove incorporated at the other of the opposing ends for engagement with any of the other leveling sections for forming a multi-section level, each section being aligned with the other sections so that all of the flat surfaces thereon are in mutual coplanar contiguous alignment.

6. The compound level of claim 5, wherein said third leveling section is L-shaped.

7. The compound level of claim 5, wherein said third leveling section is T-shaped.

8. A compound level for sensing orientation of a work surface comprising:
at least a first leveling section and a second leveling section, each of said sections having first and second ends, including a longitudinal axis and at least one external flat surface, said external parallel surface positioned parallel to the longitudinal axis, for contact with the work surface and at least one orientation sensor positioned for indicating orientation of the work surface when the external flat surface is brought into contact therewith;
said first section further comprising a tongue extending longitudinally from one of said ends, wherein said tongue further comprises an insert made of a wear resistant material connected thereto;
said second section defining a longitudinally oriented groove within one of said ends, said groove positioned and configured to accept said tongue therein, said groove including a longitudinally directed, flat, end-stop surface fixed in parallel with said external flat surface, and a longitudinally directed, flat, oblique surface positioned at an acute angle with said end-stop surface, said tongue having end-stop and oblique, longitudinally directed flat surfaces positioned at said acute angle therebetween and sized and oriented for intimately mating with the end-stop and oblique surfaces of the groove respectively; and
a locking cam located within said second section, said locking cam configured to apply a lateral force upon said insert; said lateral force directed offset to, and approximately in parallel with, said external flat surface, such that the respective oblique and end stop surfaces are caused to move into mutual contact, thereby achieving coplanar alignment of the respective external flat surfaces of the respective sections.

9. The compound level of claim 8 wherein said locking cam comprises a lever integrally formed with said cam.

10. The compound level of claim 9 wherein said locking cam pivotally connected within said second section by cam pins.

11. The compound level of claim 8 further comprising at least one third leveling section, said third leveling section providing first and second ends and having an external flat surface for contact with the work surface, and at least one orientation sensor arranged for indicating orientation of the work surface, and a further tongue extending from one of the first and second ends, and a further groove incorporated at the other of the opposing ends for engagement with any of the other leveling sections for forming a multi-section level, each section being aligned with the other sections so that all of the flat surfaces thereon are in mutual coplanar contiguous alignment.

12. The compound level of claim 11, wherein said third leveling section is L-shaped.

13. The compound level of claim 11, wherein said third leveling section is T-shaped.

14. A compound level for sensing orientation of a work surface comprising:
at least a first leveling section, a second leveling section and a third leveling section, each of said sections having first and second ends, including a longitudinal axis and at least one external flat surface, said external parallel surface positioned parallel to the longitudinal axis, for contact with the work surface and at least one orientation sensor positioned for indicating orientation of the work surface when the external flat surface is brought into contact therewith;
said first section further comprising a tongue extending longitudinally from one of said ends, wherein said tongue further comprises an insert made of a wear resistant material connected thereto;
said second section defining a longitudinally oriented groove within one of said ends, said groove positioned and configured to accept said tongue therein, said groove including a longitudinally directed, flat, end-stop surface fixed in parallel with said external flat surface, and a longitudinally directed, flat, oblique surface positioned at an acute angle with said end-stop surface, said tongue having end-stop and oblique, longitudinally directed flat surfaces positioned at said acute angle there between and sized and oriented for intimately mating with the end-stop and oblique surfaces of the groove respectively;
said third leveling section providing first and second ends and having an external flat surface for contact with the work surface, and at least one orientation sensor arranged for indicating orientation of the work surface, and a further tongue extending from one of the first and second ends, and a further groove incorporated at the other of the opposing ends for engagement with any of the other leveling sections for forming a multi-section level, each section being aligned with the other sections so that all of the flat surfaces thereon are in mutual coplanar contiguous alignment; and
a locking cam located within said second section, said locking cam configured to apply a lateral force upon said insert; said lateral force directed offset to, and approximately in parallel with, said external flat surface, such that the respective oblique and end stop surfaces are caused to move into mutual contact, thereby achieving coplanar alignment of the respective external flat surfaces of the respective sections.

15. The compound level of claim 14 wherein said locking cam comprises a lever integrally formed with said cam.

16. The compound level of claim 15 wherein said locking cam pivotally connected within said second section by cam pins.

17. The compound level of claim 14, wherein said third leveling section is L-shaped.

18. The compound level of claim 14, wherein said third leveling section is T-shaped.
